(19) United States
(12) Patent Application Publication
(10) Pub. No.: US 2014/0260524 A1
(43) Pub. Date: Sep. 18, 2014

(54) PHANTOM, ULTRASOUND SYSTEM INCLUDING THE SAME, AND METHOD OF MANUFACTURING THE PHANTOM

(71) Applicant: Samsung Electronics Co., Ltd., Suwon-si (KR)

(72) Inventors: Joon-ho SEO, Seoul (KR); Won-chul BANG, Seongnam-si (KR)

(73) Assignee: Samsung Electronics Co., Ltd., Suwon-si (KR)

(21) Appl. No.: 14/025,190

(22) Filed: Sep. 12, 2013

(30) Foreign Application Priority Data
Mar. 15, 2013 (KR) 10-2013-0028239

(51) Int. Cl. G01N 29/30

(52) U.S. Cl. CPC G01N 29/30
USPC 73/1.86; 252/583

(57) ABSTRACT

Provided is a phantom including a medium that is visually transparent, solid particles, included in the medium that are visually transparent and are able to scatter a first ultrasound, and a contrast agent included in the medium that is changed to be in an opaque state from a visually transparent state by irradiation of a second ultrasound. Also provided are an ultrasound system including the phantom, and a method of manufacturing the phantom.

### CROSS-REFERENCE TO RELATED APPLICATION

This application claims the benefit of Korean Patent Application No. 10-2013-0028239 filed on Mar. 15, 2013, in the Korean Intellectual Property Office, the entire disclosure of which is incorporated herein by reference for all purposes.

### BACKGROUND

1. Field

The following description relates to phantoms, ultrasound systems including the same, and methods of manufacturing the phantoms.

2. Description of the Related Art

Recently, when treating diseases, there has been a trend of increasing emphasis on quality of life after an operation. Accordingly, even with respect to a serious illness, such as cancer, there is a demand for non-invasive or less-invasive treatments, instead of a conventional treatment method.

For example, a less-invasive treatment, which is mainly used for clinical treatment, includes a method, as used in endoscopic surgery or laparoscopic surgery, of inserting a tubular guide into the body and a method, as used in cauterization using radio waves, of inserting a needle-shaped therapeutic apparatus into the body to irradiate radio waves. These methods, though to a lesser extent than other treatment options, still involve penetration of an apparatus into the body.

Ultrasound, if used in a manner that considers the relationship between the wavelength of the ultrasound and the attenuation characteristics of the ultrasound in the body, is capable of being focused from the outside of the body to an inside area of 1 cm×1 cm or less of the body, without inserting an apparatus into the body or otherwise physically penetrating a subject's tissue. Because of these advantages, clinical applications of such less-invasive ultrasound treatment began.

Currently, the most advanced clinical ultrasound therapy is high-intensity focused ultrasound (HIFU) therapy targeting uterine myoma and breast cancer. The HIFU therapy irradiates HIFU to an affected area, increases a temperature of the affected area above a temperature of protein coagulation within several seconds, and cauterizes the affected tissues. By focusing the HIFU energy as discussed above, energy is only incident upon a desired area, and it is not necessary to penetrate the skin or other tissues to deliver the therapeutic ultrasound energy.

Also, in regard to other ultrasound therapies, there are sonodynamic therapy in which a target, such as a tumor, is cauterized by active oxygen generated by a phenomenon called acoustic cavitation through interaction between a sensitizer and ultrasound, and ultrasound-accelerated drug therapy that promotes drug effects by improving permeability and distribution of existing drugs to the affected area.

In the above-described ultrasound therapies, since an ultrasonic generator is not in contact with a site being treated, there is a need to monitor the site being treated with an image diagnostic apparatus. In an example, the image diagnostic apparatus includes a diagnostic ultrasound generator. Also, for guaranteeing a more selective treatment, it is important to make a treatment plan in advance. Further, it is important to control that an appropriate amount of ultrasound is irradiated to a site being treated and that an inappropriate amount of ultrasound is not irradiated to a surrounding sites, which are not necessary to be treated. If surrounding sites are irradiated excessively, it may damage tissue of the patient in a manner that is not intended.

Thus, as a target for pre-determining an area to be irradiated by an ultrasound or for assessing the degree of ultrasonic irradiation in the body, a phantom that mimics a living body is required. A phantom is an object that may be scanned or imaged in order to verify the functionality of an imaging device. The phantom mimics an actual subject, but also provides data about the functionality of the imaging device.

Since the phantom used in conventional HIFU therapy is visually transparent, changes in physical properties of the phantom are confirmed by discoloration or the like in an area of the phantom where the HIFU is irradiated. However, such discoloration only occurs in a limited set of conditions. For example, the discoloration occurs only at a temperature above a certain critical point. In this case, the phantom may not provide information about effects of the HIFU where that critical point is not achieved.

Therefore, currently phantoms lack a way to visually observe certain internal changes, of which evidence and observation would be useful.

### SUMMARY

Provided are phantoms that are visually transparent and are able to be imaged under diagnostic ultrasound.

In one general aspect, a phantom includes a transparent medium, solid particles in the transparent medium configured to be transparent and to scatter a first ultrasound, and a contrast agent in the transparent medium configured to change from a transparent state into an opaque state by irradiation from a second ultrasound.

The phantom may include that the solid particles are formed from at least one of glass, polymer, or a particulate gel.

The phantom may include that a diameter of the solid particles is one-fourth or more of a wavelength corresponding to a natural frequency of the first ultrasound.

The phantom may include that the solid particles are spheres or spheroids and a diameter of the solid particles is in a range from 150 μm to 250 μm.

The phantom may include that an amount of the solid particles is in a range from 0.1 g to 0.3 g per 100 ml of the phantom without including the solid particles.

The phantom may include that the contrast agent is a water-soluble protein.

The phantom may include that the water-soluble protein is at least one of bovine serum albumin (BSA), egg white, and albumin.

The phantom may include that the transparent medium is a gel-forming material and the transparent state is a visually transparent state.

The phantom may include that the gel-forming material is at least one of polyvinyl alcohol (PVA), agarose, gelatin, acrylamide, N,N′-methylenebisacrylamide, ammonium persulfate, and N,N,N′,N′-tetramethylethylenediamine.

The phantom may include that the second ultrasound is a high-intensity focused ultrasound.

In another general aspect, an ultrasound system includes a phantom including a transparent medium, solid particles in the transparent medium configured to be transparent and to scatter a first ultrasound, and a contrast agent in the transparent medium configured to change from a transparent state into an opaque state by irradiation from a second ultrasound, an ultrasound therapeutic apparatus, and an ultrasound diagnostic apparatus.

The ultrasound system may include that the ultrasound therapeutic apparatus uses a high-intensity focused ultrasound.

The ultrasound system may include that the ultrasound diagnostic apparatus comprises a display unit displaying temperature changes in the phantom to which the high-intensity focused ultrasound is irradiated.

The ultrasound system may include that the display unit displays temperature changes in the phantom with a lack of cavity generation inside the phantom.

In another general aspect, a method of manufacturing a phantom includes preparing a visually transparent mixture comprising a contrast agent, wherein the contrast agent can be changed from a visually transparent state into an opaque state by ultrasound irradiation, adding visually transparent solid particles capable of scattering ultrasound, into the mixture, and hardening the mixture.

The method may further include adding at least one of a pH adjustor, a gel-forming agent, and a catalyst, into the mixture.

The method may further include deaerating the mixture after preparing the mixture.

The hardening of the mixture may further include adding a hardener to the mixture and sealing the mixture comprising the hardener, and rotating the sealed mixture until the sealed mixture is completely hardened.

The method may include that the solid particles are added at a ratio in a range from 0.1 g to 0.3 g per 100 ml of the hardened mixture without including the solid particles.

The method may include that the solid particles are spheres or spheroids and a diameter of the solid particles is in a range from 150 μm to 250 μm.

The ultrasonic therapeutic apparatus may be configured to compare settings of a therapeutic ultrasound with information about changes in the contrast agent to calibrate the ultrasound therapeutic apparatus.

The ultrasonic diagnostic apparatus may be configured to compare settings of a diagnostic ultrasound with scan results to calibrate the ultrasound diagnostic apparatus.

The ultrasound system may further include a display configured to display information of at least one of information about changes in the contrast agent and the shape of the phantom displaying information of at least one of information about changes in the contrast agent and the shape of the phantom.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings.

FIG. 1 is an image showing transparency of a phantom prepared according to an embodiment of the present inventive concept.

FIG. 2 is an image showing opaque discoloration after irradiating high-intensity focused ultrasound (HIFU) on the phantom prepared according to an embodiment of FIG. 1.

FIG. 3 is a B-mode ultrasound image of the phantom prepared according to an embodiment of FIG. 1.

FIG. 4A is an ultrasound image of the phantom prepared according to an embodiment of FIG. 1 in which the ultrasound image shows a change of temperature in the manner of changes in backscattering energy (CBE).

FIG. 4B is an ultrasound image of the phantom prepared according to an embodiment of FIG. 1 in which the ultrasound image shows a change of temperature in the manner of echo shift of ultrasound.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a phantom according to exemplary embodiments, an ultrasound system including the phantom, and a method of manufacturing the phantom will be described in detail. Additionally, the phantom may be used to provide information about the effects of therapeutic and diagnostic ultrasound apparatuses.

According to an embodiment of the present inventive concept, a phantom includes a visually transparent medium, solid particles that are visually transparent and are able to scatter a first ultrasound, and a contrast agent capable of being changed from a visually transparent state to an opaque state by a second ultrasound irradiation. By including the solid particles and the contrast agent, when the phantom is subjected to therapeutic and/or diagnostic ultrasound emission, the phantom responds in a useful way that helps characterize the ultrasound. The phantom and how the phantom responds are now discussed in greater detail.

The phantom includes the solid particles, and thus temperature changes of the phantom may be imaged with ultrasound, because as discussed the solid particles are able to scatter a first ultrasound. Without the solid particles, the ultrasound would simply pass through the medium, as it is transparent. Also, the phantom includes the contrast agent, and thus temperature changes by high-intensity focused ultrasound (HIFU) may be visually represented, in that when the contrast agent receives the second ultrasound irradiation, it changes from a visually transparent state to an opaque state. Hence, the contrast agent becomes visible while the medium is visually transparent, and it is possible to observe where the ultrasound irradiation was received because the contrast agent acts as a marker for those areas. The changes in the contrast agent are actually visible upon inspection.

Therefore, in embodiments, changes in physical properties, for example, temperature changes in a HIFU-irradiated area, are visually monitored. At the same time, in some embodiments, changes of the phantom are monitored using ultrasound. For example, invisible changes occurring in a predetermined area during HIFU irradiation are confirmed using ultrasound. Thus, an effect of HIFU irradiation on the phantom may be assessed more accurately, and accordingly, the performance of HIFU may be assessed and compared more accurately. Therefore, the phantom is able to provide useful information that can be used to configure and adjust ultrasound before it is used on a human subject. For example, if the HIFU is too intense, the phantom indicates this by changes in the contrast agent that are excessive.

In embodiments, the solid particles included in the phantom are at least one selected from the group consisting of glass particles, polymer particles, and particulate gels, but the solid particles are not limited thereto. Any solid particle available in the art may be used in embodiments if the solid particle is transparent and is able to scatter ultrasound. The solid particles are homogeneously scattered in the medium in some embodiments. Alternatively, in other embodiments, the solid particles are distributed more or less closely to one another in areas of the phantom, for example if there is a subregion of the phantom that is of interest, where changing the distribution of the solid particles will be useful.

The term “able to scatter ultrasound” used herein refers to that the solid particles may be imaged with diagnostic ultrasound. That is, the solid particles are not transparent with respect to the diagnostic ultrasound. Thus, the solid particles should have a different response to diagnostic ultrasound than the response of the medium. If the solid particles are not transparent with respect to the diagnostic ultrasound, they will appear in ultrasound scans of the phantom and the results of scanning the solid particles in the phantom will provide information about the characteristics of the phantom's response to ultrasound.

In an example embodiment, the solid particles are each large enough to cause a measurable ultrasound dispersion. Alternatively, the solid particles are so small and so densely arranged that each of the solid particles are not individually detected in an ultrasound image for diagnosis. For example, a size of the solid particle may be ¼ or more of a wavelength corresponding to a natural frequency of the first diagnostic ultrasound. When the size of the solid particle is less than ¼ of the wavelength of the natural frequency of the first diagnostic ultrasound, it is not possible to individually image the solid particles with diagnostic ultrasound. Therefore, the type of information gathered by performing diagnostic ultrasound on the phantom will vary based on the wavelength of the natural frequency of the first diagnostic ultrasound.

For example, in some embodiments, when the natural frequency of the first diagnostic ultrasound is 2.5 MHz and a sound velocity in gel is 1500 m/s, the size of the solid particles is 150 μm or greater. Such embodiments may include various ranges for the sizes of solid particles in embodiments in which the natural frequency of the first diagnostic ultrasound is 2.5 MHz and a sound velocity in gel is 1500 m/s.

In some embodiments, the solid particles are formed as spheres or spheroids, such that a spheroid indicates a solid particle that approximates a sphere. However, in other embodiments the solid particles take on other shapes, such as cubes or irregular solids. The size considerations discussed below are directed towards diameters of spheres or spheroids, but other shapes of particles that are of similar sizes are used in other embodiments.

In one example range, the size of the solid particles is in a range from 150 μm to 1000 μm. In another example range, the size of the solid particles may be in a range from 150 μm to 500 μm. In another example range, the size of the solid particles may be in a range from 150 μm to 250 μm. As discussed above, the size of the solid particles and their relationship to the natural frequency of the first diagnostic ultrasound and a sound velocity through the medium will determine which information scanning the phantom with the first diagnostic ultrasound will provide. Thus, the size of the solid particles that are used should be based upon a consideration of the characteristics of the first diagnostic ultrasound. Additionally, these ranges are provided as example ranges, and other embodiments may use other ranges in which the solid particles are larger or smaller.

In an embodiment, an amount of the solid particles included in the phantom is in a range from 0.1 g to 0.3 g per 100 ml of the phantom without including the solid particles. In an example range, the amount of the solid particles included in the phantom is in a range from 0.2 g to 0.3 g per 100 ml of the phantom without including the solid particles. Within the ranges above, a clearer diagnostic ultrasound image may be obtained. However, these ranges are provided as example ranges, and other embodiments may use other ranges in which the amount of solid particles is larger or smaller. Additionally, in some embodiments, the amount of solid particles is adjusted to provide the best image quality.

A specific gravity of the solid particles is not particularly limited in the phantom. However, some embodiments include specific gravities rendering the solid particles homogeneously scattered in the medium. In an embodiment, the specific gravity of the solid particles is in a range from 0.1 to 10. In an example range, the specific gravity of the solid particles is in a range from 0.5 to 2. In another example range, the specific gravity of the solid particles is in a range from 0.9 to 1.1. However, these ranges are provided as example ranges, and other embodiments may use other ranges in which the specific gravity is greater or lesser. In an embodiment, when the specific gravity of the solid particles has a large difference from 1, the solid particles are homogeneously scattered by using a mixing method and/or a curing method appropriately. For example, the solid particles may be agitated to ensure homogeneity until the medium hardens.

In some embodiments, the medium included in the phantom is an aqueous solvent. An example of the aqueous solvent is water, but it is not limited thereto. The solvent may contain water more than 50% by the volume of the solvent and may additionally include other polar solvents, such as alcohols such as ethanol or organic acids such as acetic acid. However, other embodiments use other polar solvents to serve as all or part of the medium.

In some embodiments, the contrast agent included in the phantom is a water-soluble protein. The water-soluble protein is soluble in water at room temperature and is transparent. However, as the temperature increases, the water-soluble protein may be denatured and then become opaque. Additionally, once the water-soluble protein is denatured, it may take on various colors, such as an opaque whitish color, although other colors are possible as well.

In an example, the water-soluble protein is at least one selected from the group consisting of bovine serum albumin (BSA), egg white, and albumin. Such water-soluble proteins are soluble in water at room temperature and are initially transparent. However, when subjected to energy that denatures them, they become opaque. In the case of the ultrasound, the ultrasound energy becomes thermal energy, which acts to denature the protein. Examples of the water-soluble protein are not limited thereto, and any water-soluble protein available in the art may be used if thermal denaturation is possible. In some embodiments, the water-soluble protein solution is colorless, but other embodiments include protein solutions that are colored but transparent.

Optionally, the medium included in the phantom include a gel-forming material, in which case the medium may be solid or semisolid after hardening. If the medium is a gel-forming material, the solid particles and contrast agent may be introduced into the medium and the medium is hardened into a free-standing phantom.

Where a gel-forming material is used, example gel-forming materials include a mixture including at least one selected from the group consisting of polyvinyl alcohol (PVA), agarose, gelatin, acrylamide, N,N′-methylenebisacrylamide, ammonium persulfate, and N,N,N′,N′-tetramethylethylenediamine. However, examples of the gel-forming material are not limited thereto, and other embodiments exist that include other gel-forming materials available as gel in the art.

For example, acrylamide and N,N′-methylenebisacrylamide are mixed in the presence of a catalyst, and then through a cross-linking reaction a polyacrylamide gel is obtained and the gel is used in the phantom. Such a gel provides hardness and stability for the phantom.

In regard to the phantom, the second ultrasound may be used for therapeutic purposes. For example, the second ultrasound may include HIFU.

In regard to the phantom, the first ultrasound is used for diagnostic purposes. For example, the first ultrasound includes diagnostic ultrasound.

For example, in the phantom, the second ultrasound is HIFU, and the first ultrasound is diagnostic ultrasound. The phantom responds to the different types of ultrasound in different ways.

According to another embodiment, an ultrasound system includes the above-described phantom, an ultrasound therapeutic apparatus, and an ultrasound diagnostic apparatus.

The ultrasound system includes the phantom that provides evidence about the effects of the ultrasound irradiation more exactly, and thus operating conditions of the ultrasound therapeutic apparatus are controlled and assessed more exactly, thereby providing more improved effects of ultrasound therapy. Additionally, the phantom offers the ability to respond to both therapeutic ultrasound, such as HIFU, and diagnostic ultrasound, to provide information.

The ultrasound therapeutic apparatus may use HIFU. Also, the ultrasound diagnostic apparatus may use diagnostic ultrasound.

The ultrasound diagnostic apparatus optionally includes a display unit that displays temperature changes of the phantom irradiated by the HIFU. On the display unit, velocity changes of scattered ultrasound, which lead to a temperature change of the phantom, are imaged. In some embodiments the display unit displays ultrasound by modes such as B-mode ultrasound, a mode of changes in backscattering energy (CBE) of ultrasound, and the like. However, the modes that the display unit uses in examples to display ultrasound results are not limited thereto. Also, coloration or grayscale are optionally used to help indicate information from the ultrasound. Embodiments use any display unit available in the art when the display unit is compatible with an ultrasound imaging method. Since the ultrasound diagnostic apparatus includes the display unit displaying temperature changes of the phantom, the temperature changes are observed continuously and even temperature changes that are not visually represented are observable.

For example, the display unit of the ultrasound diagnostic apparatus displays temperature changes of the phantom by a heat as an image, even in the condition that a cavity is not formed within the phantom. That is, a change of temperature within the phantom is imaged with the ultrasound before forming pores to image thermal evaporation of the solvent and the like within the phantom.

According to another embodiment of the present inventive concept, a method of manufacturing a phantom includes preparing a visually transparent mixture that includes a contrast agent capable of being changed from a visually transparent state to an opaque state by ultrasound irradiation, putting visually transparent solid particles capable of scattering ultrasound into the mixture, and hardening the mixture. For example, the mixture is hardened by turning it into a gel that is a solid or a semisolid. By hardening the mixture, it is possible for the phantom to be a free-standing unit that is targeted by ultrasound.

Based on the manufacturing method of the phantom, a phantom, capable of observing invisible temperature changes, in addition to visual temperature changes, is obtained.

In the manufacturing method of the phantom, in various options the mixture further includes at least one selected from a pH adjuster, a gel-forming material, and a catalyst.

In an example, the pH adjuster is a 2-amino-2-hydroxymethylpropane-1,3-diol (TRIS) buffer. However, the pH adjuster is not limited thereto, and any pH adjuster available is usable if the pH adjuster functions as a buffer.

In an example, the gel-forming material is polyacrylamide. However, the gel-forming material is not limited thereto, and any gel-forming material available is usable if a polymer is able to form gel.

The catalyst accelerates the hardening reaction. In an example, the catalyst is N,N,N′,N′-tetramethylethylenediamine. However, the catalyst is not limited thereto, and any catalyst available in the art may be used if the catalyst is able to be used as a catalyst in this context.

In the manufacturing method of the phantom, the method further includes deaerating the mixture after preparing the mixture. When all air bubbles in the mixture are removed, a clearer ultrasound image is obtained. For example, the deaerating is performed for 20 minutes to 2 hours. However, embodiments may deaerate for greater or longer amounts of time. For example, the mixture may be connected to a vacuum pump to help remove air bubbles.

In the manufacturing method of the phantom, the hardening of the mixture may include putting a hardener into the mixture and sealing the mixture including the hardener, and rotating the sealed mixture until it is completely hardened. For example, the hardener is added to the mixture, and ingredients included in the mixture are able to form polymer gel by the cross-linking reaction, as discussed above. Also, the sealed mixture may be rotated until it is completely hardened, and thus the solid particles may be evenly distributed without being precipitated by gravity in the hardened mixture.

In one embodiment, the phantom is manufactured in a transparent container. When the mixture is completely hardened in the container, the phantom is separated from the container.

The solid particles used in the preparation method may be added in a range from 0.1 g to 0.3 g, included per 100 ml of the hardened mixture without including the solid particles. The diameter of the solid particles to be added to the mixture may be in a range from 150 μm to 250 μm. As noted previously, these ranges are chosen as general examples and actual ranges of embodiments may include greater or lower values.

Hereinafter, the present invention is described in detail with reference to Examples and Comparative Examples. However, the present invention is not limited to the Examples and the Comparative Examples. Instead, the Examples and Comparative Examples are intended to help illustrate how various embodiments operate and are structured.

(Manufacture of Phantom)

Note that manufacturers in Examples are simply examples and are not intended to be limiting.

### Example 1

### Phantom with BSA 7%

In a cubic transparent container having an opening on an upper surface, 37 ml of distilled water, 24 ml of acrylamide 40 w/v % solution (such as acrylamide:N,N′hethylenebisacrylamide=19:1, ICN Biomedicals, Aurora, Ohio, USA), 3.9 ml of 1M TRIS pH 8 buffer (such as trizma hydrochloride and trizma base, Sigma Chemical, St Louis, Mo., USA), 0.3 ml of N,N,N′,N′-tetramethylethylene/diamine (such as TEMED, Sigma), and 28 ml of bovine serum albumin (BSA) 25% solution (such as Sigma aldrich) are mixed together. The container, including the mixture, is connected to a vacuum pump, and the container is maintained at a pressure of −30 Hg for 30 minutes for deaeration. In the deaerated mixture, 0.3 g of glass particles having a diameter of 180 μm is added thereto, and also 1.4 ml of ammonium persulfate 10% solution (such as APS, Sigma) is slowly injected to the mixture as a hardener. Then, the opening of the transparent container is closed with a lid and sealed. In order to prevent precipitation due to gravity of the glass particles, the sealed container is rotated at a constant speed until the mixture was hardened. After it is confirmed that the mixture was completely hardened and a cube phantom was manufactured, the phantom is separated from the container. The glass particles are glass spheres. This example approach yields an example phantom as disclosed above.

### Example 2

A phantom was manufactured in the same manner as in Example 1, except that a diameter of the glass particles was changed to 150 μm.

### Example 3

A phantom was manufactured in the same manner as in Example 1, except that a diameter of the glass particles was changed to 200 μm.

### Example 4

A phantom was manufactured in the same manner as in Example 1, except that a diameter of the glass particles was changed to 250 μm.

### Example 5

A phantom was manufactured in the same manner as in Example 1, except that a total concentration of the BSA was changed to 3% (phantom with BSA 3%).

### Example 6

A phantom was manufactured in the same manner as in Example 1, except that a total concentration of the BSA was changed to 5% (phantom with BSA 5%).

### Example 7

A phantom was manufactured in the same manner as in Example 1, except that a total concentration of the BSA was changed to 9% (phantom with BSA 9%).

### Comparative Example 1

A phantom was manufactured in the same manner as in Example 1, except that glass particles were not added.

### Evaluation Example 1

### Evaluation of Visual Transparency

The phantom manufactured according to Example 1 is visually transparent, as is shown in FIG. 1.

### Evaluation Example 2

### Evaluation of Thermal Denaturation According to Temperature Changes

The phantom manufactured according to Example 1 was irradiated with high-intensity focused ultrasound (HIFU) for 60 seconds in a HIFU apparatus to evaluate the presence of opaqueness, the HIFU apparatus having a frequency of 1.0 MHz and a power density of 1000 W/cm².

As shown in FIG. 2, water-soluble protein in an area in which HIFU was irradiated was denatured by heat, and a part of the phantom became opaque. For example, a rounded region above the 90 mm and 110 mm marks on the ruler is a region where the contrast agent has become opaque, marking the area targeted with HIFU. The region has become opaque because the medium and solid particles remain transparent, along with the contrast agent in the parts of the medium that were not subject to HIFU. However, the contrast agent in the areas that received the HIFU has denatured, turning into an opaque area that is visually observable in the phantom.

Therefore, the effects of the incineration to effect the removal of particular proteins using HIFU irradiation in the human body were confirmed.

### Evaluation Example 3

### Measurement of Ultrasound Images

While HIFU was irradiated to the phantom in Evaluation Example 2, ultrasound image was measured using an ultrasound diagnostic apparatus.

As shown in FIG. 3 and FIGS. 4A and 4B, with respect to the phantom manufactured according to Example 1, an ultrasound image showing a shape of the phantom clearly was obtained.

In FIGS. 4A and 4B, an area in which a temperatures increases is separately shown with different colors. In FIG. 4A, an area represented by a circle in the center is an area in which a temperature increases due to HIFU irradiation. FIG. 4B is an image representing an amount of eco-shifted ultrasound in FIG. 4A.

Although not illustrated, changes in ultrasound images according to temperature changes in an area in which HIFU was irradiated were continuously observed. Further, before opaqueness and/or pore formation due to an increase in temperature of phantom are visually observed, a change of ultrasound images due to temperature changes are observed.

Meanwhile, in the phantom manufactured according to Comparative Example 1, no ultrasound image was obtained during HIFU irradiation to the phantom. That is, since the phantom manufactured according to Comparative Example 1 is acoustically transparent (i.e., transparent with respect to ultrasound), due to the absence of the solid particles, a continuous observation of ultrasound image change of phantom due to temperature changes is not possible.

As described above, according to the one or more of the above embodiments of the present inventive concept, a phantom includes a contrast agent and solid particles at the same time, thereby observation of simultaneous internal changes of the phantom by visual and ultrasonic ways. Thus, the phantom of embodiments provide an advantageous way to get information about ultrasound therapies, and other embodiments utilize or produce such phantoms with advantageous attributes.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

As a non-exhaustive illustration only, a terminal/device/unit described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A phantom comprising:
a transparent medium;
solid particles in the transparent medium configured to be transparent and to scatter a first ultrasound; and
a contrast agent in the transparent medium configured to change from a transparent state into an opaque state by irradiation from a second ultrasound.

2. The phantom of claim 1, wherein the solid particles are formed from at least one of glass, polymer, or a particulate gel.

3. The phantom of claim 1, wherein a diameter of the solid particles is one-fourth or more of a wavelength corresponding to a natural frequency of the first ultrasound.

4. The phantom of claim 1, wherein the solid particles are spheres or spheroids and a diameter of the solid particles is in a range from 150 μm to 250 μm.

5. The phantom of claim 1, wherein an amount of the solid particles is in a range from 0.1 g to 0.3 g per 100 ml of the phantom without including the solid particles.

6. The phantom of claim 1, wherein the contrast agent is a water-soluble protein.

7. The phantom of claim 6, wherein the water-soluble protein is at least one of bovine serum albumin (BSA), egg white, and albumin.

8. The phantom of claim 1, wherein the transparent medium is a gel-forming material and the transparent state is a visually transparent state.

9. The phantom of claim 8, wherein the gel-forming material is at least one of polyvinyl alcohol (PVA), agarose, gelatin, acrylamide, N,N′-methylenebisacrylamide, ammonium persulfate, and N,N,N′,N′-tetramethylethylenediamine.

10. The phantom of claim 1, wherein the second ultrasound is a high-intensity focused ultrasound.

11. An ultrasound system comprising
a phantom, comprising:
a transparent medium;
solid particles in the transparent medium configured to be transparent and to scatter a first ultrasound; and
a contrast agent in the transparent medium configured to change from a transparent state into an opaque state by irradiation from a second ultrasound;
an ultrasound therapeutic apparatus; and
an ultrasound diagnostic apparatus.

12. The ultrasound system of claim 11, wherein the ultrasound therapeutic apparatus is configured to use a high-intensity focused ultrasound.

13. The ultrasound system of claim 11, wherein the ultrasound diagnostic apparatus is configured to comprise a display unit displaying temperature changes in the phantom to which the high-intensity focused ultrasound is irradiated.

14. The ultrasound system of claim 13, wherein the display unit is configured to display temperature changes in the phantom with a lack of cavity generation inside the phantom.

15. A method of manufacturing a phantom, the method comprising:
preparing a visually transparent mixture comprising a contrast agent, wherein the contrast agent can be changed from a visually transparent state into an opaque state by ultrasound irradiation;
adding visually transparent solid particles capable of scattering ultrasound, into the mixture; and
hardening the mixture.

16. The method of claim 15, further comprising:
adding at least one of a pH adjustor, a gel-forming agent, and a catalyst, into the mixture.

17. The method of claim 15, further comprising:
deaerating the mixture after preparing the mixture.

18. The method of claim 15, wherein the hardening of the mixture further comprises:
adding a hardener to the mixture and sealing the mixture comprising the hardener; and
rotating the sealed mixture until the sealed mixture is completely hardened.

19. The method of claim 15, wherein the solid particles are added at a ratio in a range from 0.1 g to 0.3 g per 100 ml of the hardened mixture without including the solid particles.

20. The method of claim 15, wherein the solid particles are spheres or spheroids and a diameter of the solid particles is in a range from 150 μm to 250 μm.
